(19) United States
(12) Patent Application Publication
(10) Pub. No.: US 2026/0072626 A1
(43) Pub. Date: Mar. 12, 2026

(54) IMAGE FORMING APPARATUS, METHOD OF CONTROLLING IMAGE FORMING APPARATUS, AND MEDIUM

(71) Applicant: CANON KABUSHIKI KAISHA, Tokyo (JP)

(72) Inventor: Hiroyuki Shioiri, Kanagawa (JP)

(21) Appl. No.: 19/310,111

(22) Filed: Aug. 26, 2025

(30) Foreign Application Priority Data
Sep. 6, 2024 (JP) 2024-154232

(51) Int. Cl. G06F 3/12

(52) U.S. Cl. CPC G06F 3/1219; G06F 3/1243

(57) ABSTRACT

An image forming apparatus is provided. The apparatus receives a print job. The apparatus determines, based on a result of estimating legibility of a code image printed on a print target base material, whether or not to print a background of a code image included in a print image. The print image is to be printed in accordance with the print job. The apparatus provides an instruction to print in accordance with the print job and a result of the determination.

### BACKGROUND

### Field of the Technology

The present disclosure relates to an image forming apparatus, a method of controlling an image forming apparatus, and a medium, in particular to control when printing a code image.

### Description of the Related Art

In print, a spot color material (e.g., spot color ink such as white ink) is used in addition to a normal color material (e.g., process ink) such as CMYK. For example, Japanese Patent Laid-Open No. 2014-97671 discloses use of white ink for background treatment of a print medium. Japanese Patent Laid-Open No. 2014-97671 proposes, in particular, improving reading accuracy of a barcode by printing a background of the barcode using only white ink and not mixing color ink with white ink.

### SUMMARY

One embodiment of the present disclosure can reduce consumption of a color material for printing a code image while maintaining reading accuracy of the code image.

According to an embodiment, an image forming apparatus comprises one or more memories storing instructions and one or more processors that execute the instructions to: receive a print job; determine, based on a result of estimating legibility of a code image printed on a print target base material, whether or not to print a background of a code image included in a print image, wherein the print image is to be printed in accordance with the print job; and provide an instruction to print in accordance with the print job and a result of the determination.

According to another embodiment, an image forming apparatus comprises one or more memories storing instructions and one or more processors that execute the instructions to: set whether or not to print a background of a print image; receive a print job; and provide an instruction to print in accordance with the print job so as to print a first background image as a background of a code image included in a print image in response to a setting not to print a background of the print image, wherein the print image is to be printed in accordance with the print job.

According to an embodiment, a method of controlling an image forming apparatus comprises: receiving a print job; determining, based on a result of estimating legibility of a code image printed on a print target base material, whether or not to print a background of a code image included in a print image, wherein the print image is to be printed in accordance with the print job; and providing an instruction to print in accordance with the print job and a result of the determination.

According to an embodiment, a non-transitory computer-readable medium stores a program executable by a computer to perform a method of controlling an image forming apparatus comprising: receiving a print job; determining, based on a result of estimating legibility of a code image printed on a print target base material, whether or not to print a background of a code image included in a print image, wherein the print image is to be printed in accordance with the print job; and providing an instruction to print in accordance with the print job and a result of the determination.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view illustrating a configuration example of an image forming system according to one embodiment.

FIGS. 2A and 2B are block diagrams illustrating configuration examples of an image forming apparatus according to one embodiment.

FIG. 3 is a view illustrating an example of job information to be printed.

FIG. 4 is a flowchart of a control method according to one embodiment.

FIG. 5 is a view illustrating an example of a GUI for warning display to a user.

FIG. 6 is a flowchart of the control method according to one embodiment.

FIG. 7 is a flowchart of the control method according to one embodiment.

FIG. 8 is a flowchart in an example of processing for automatic background generation.

FIG. 9 is a view illustrating an example of a GUI for automatic background generation setting.

FIG. 10 is a flowchart of the control method according to one embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

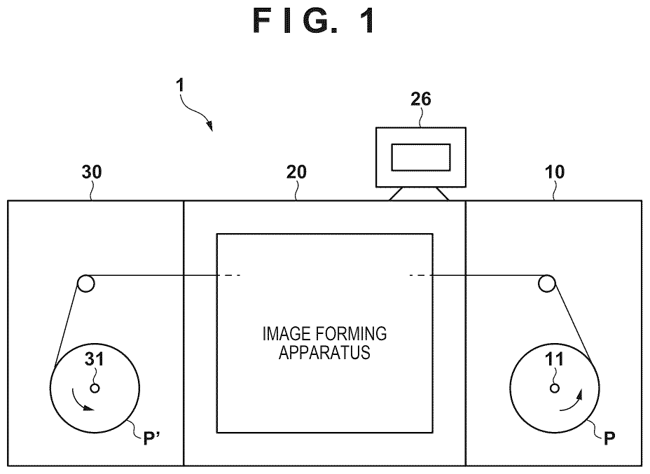

FIG. 1 is a view illustrating the configuration of an image forming system 1 according to one embodiment. The image forming system 1 performs printing on a print target base material. In the present embodiment, the image forming system 1 forms an image on roll paper (continuous paper) P on which continuous image formation is possible.

The image forming system 1 includes a paper feeding apparatus 10, an image forming apparatus 20, and a winding apparatus 30. The paper feeding apparatus 10, the image forming apparatus 20, and the winding apparatus 30 are connected in this order from the upstream side along the conveyance direction of the roll paper P.

The paper feeding apparatus 10 supplies the roll paper P to the image forming apparatus 20. The paper feeding apparatus 10 rotates a rotation shaft 11, which is a paper tube around which the roll paper P is wound. Then, the paper feeding apparatus 10 conveys the roll paper P toward the image forming apparatus 20 at a constant speed via a plurality of rollers (e.g., a conveyance roller, a paper feeding roller, and the like).

The image forming apparatus 20 forms an image on the roll paper P supplied from the paper feeding apparatus 10. The image forming apparatus 20 conveys, toward the winding apparatus 30, the roll paper P on which an image is formed.

The winding apparatus 30 winds, into a roll shape, the roll paper P conveyed from the image forming apparatus 20. In the winding apparatus 30, for example, as illustrated in FIG. 1, the roll paper P is wound around a paper tube that is a rotation shaft 31. By rotating the rotation shaft 31, the winding apparatus 30 winds the conveyed roll paper P around the paper tube at a constant speed via a plurality of rollers (e.g., a conveyance roller and a paper discharge roller). In this manner, a product P′ of roll paper is wound around the rotation shaft 31.

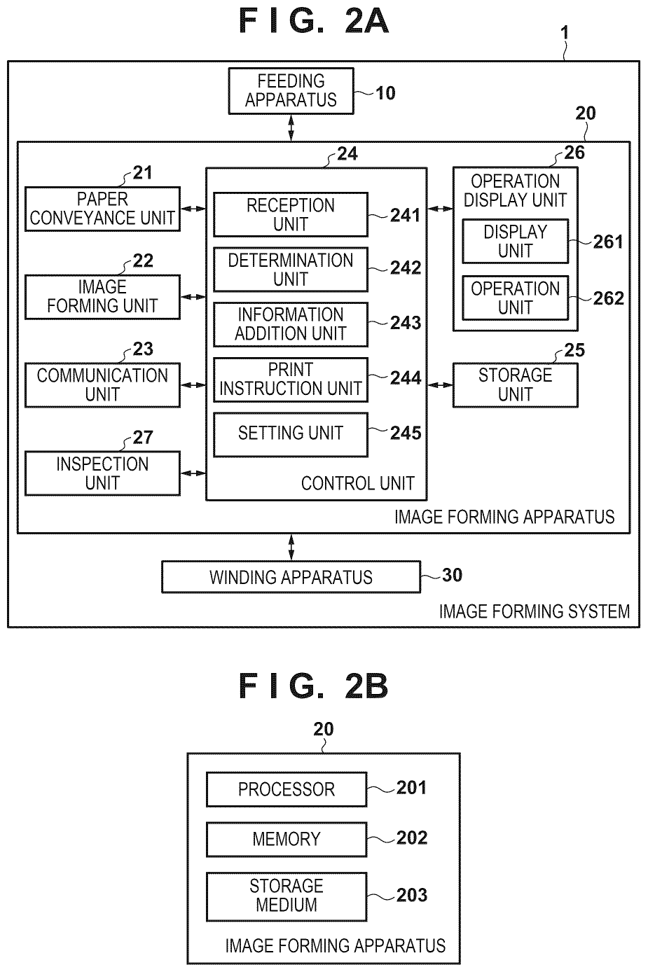

Next, a configuration for controlling the image forming apparatus 20 will be described in detail. FIG. 2A is a functional block diagram illustrating a control configuration of the image forming apparatus 20. In this figure, the paper feeding apparatus 10 and the winding apparatus 30 are illustrated as external apparatuses. As illustrated in FIG. 2A, the image forming apparatus 20 includes, for example, a paper conveyance unit 21, an image forming unit 22, a communication unit 23, a control unit 24, a storage unit 25, an operation display unit 26, and an inspection unit 27. The image forming apparatus 20 in the present embodiment functions as an information processing apparatus including the control unit 24. On the other hand, a separate information processing apparatus connected to the image forming apparatus 20 may function as the control unit 24. For example, the image forming apparatus according to one embodiment may be an information processing apparatus connected to an image forming apparatus that performs printing and including a printer driver configured to implement each process performed by the control unit 24.

The paper conveyance unit 21 is a conveyance mechanism of the roll paper P inside the image forming apparatus 20. The paper conveyance unit 21 includes, for example, a plurality of rollers. The paper conveyance unit 21 conveys, to the image forming unit 22, the roll paper P conveyed from the paper feeding apparatus 10. The paper conveyance unit 21 conveys, to the winding apparatus 30, the roll paper P having passed through the image forming unit 22.

The image forming unit 22 forms an image on the roll paper P supplied from the paper feeding apparatus 10 based on the print data instructed by the control unit 24. The image forming unit 22 conveys the roll paper P on which an image is formed toward the winding apparatus 30. In the present embodiment, the image forming unit 22 forms an image by ejecting ink. However, it is not essential to use ink as a color material. The image forming unit 22 may form an image by applying a color material such as toner to a base material. In the present embodiment, the image forming unit 22 can perform print using a color material of a process color (e.g., CMYK). The image forming unit 22 can also perform print using a spot color material (e.g., white) other than the process color.

The communication unit 23 transmits and receives various data to and from an external apparatus (e.g., a personal computer). The communication unit 23 and the external apparatus are connected to a communication network such as a LAN or a wide area network (WAN). The communication unit 23 may be, for example, a communication control card such as a local area network (LAN) card.

The control unit 24 controls processing performed by the image forming apparatus 20. For example, the control unit 24 can perform image forming processing of executing a print job or an image forming job (hereinafter, called a job) in response to a user's instruction. By executing the job, print on the print target base material is performed. In the image forming processing according to one embodiment, the control unit 24 can assign a specific Lab value or a CMYK value to a spot color name included in a received PDF job. Note that the user can designate this specific Lab value and the CMYK value via the operation display unit 26. The control unit 24 can generate print data indicating, for each pixel, a color material amount used for print based on the Lab value or the CMYK value. The control unit 24 transmits the print data to the image forming unit 22.

In the present embodiment, the print data can further indicate the amount of a spot color material (e.g., white ink) used for print. For this purpose, a spot color material may be assigned to the spot color. In this case, designation of the spot color can specify the pixel for performing printing using the spot color material. However, the PDF job may indicate an area where printing using a spot color material (e.g., white ink) is performed.

The processing performed by the control unit 24 can be implemented by using a processor and a memory. For example, as illustrated in FIG. 2B, the image forming apparatus may include a processor 201, a memory 202, and a storage medium 203. The processor 201 is, for example, a central processing unit (CPU). The memory 202 is, for example, a random access memory (RAM), and temporarily stores programs, data, and the like. The storage medium 203 that is computer-readable stores programs, data, and the like for a long period of time. The storage medium 203 is, for example, a nonvolatile semiconductor memory (what is called flash memory) or a hard disk drive (HDD). The processor 201 reads various programs such as a system program or a processing program stored in the storage medium 203 and loads them into the memory 202. Then, the processor 201 executes various processing in accordance with the deployed program.

The storage unit 25 stores various programs such as a system program or a processing program to be executed by the control unit 24. The storage unit 25 can store various data necessary for execution of these programs. The storage unit 25 can be implemented by using the storage medium 203.

The operation display unit 26 has a function of receiving various operations by the user and a function of displaying various types of information. The operation display unit 26 is, for example, a liquid crystal display (LCD) with a touch panel. The operation display unit 26 includes a display unit 26a and an operation unit 26b.

The display unit 26a displays various types of information on a display screen in accordance with a display control signal input from the control unit 24. The operation unit 26b receives various input operations by the user, and outputs a signal indicating the operation to the control unit 24. The operation unit 26b may include various operation keys such as a numeric keypad or a start key.

The operation display unit 26 can be used to set partition information when a job is executed, for example. The partition information is insertion position information on a partition page. When the product P′ of the roll paper as a plurality of windings is produced and delivered by the image forming processing, the partition page can be inserted into print data in advance. In the present embodiment, the partition information is generated by the user setting the number of printing, the number of copies, the print length, the print weight, or the print diameter.

The inspection unit 27 inspects the base material on which an image is formed by the image forming unit 22. For example, the inspection unit 27 can confirm whether printing has been performed on the roll paper without ejection failure. For example, the image forming unit 22 can print a pattern for ejection failure inspection on the base material. The inspection unit 27 can include a scanner. The inspection unit 27 can confirm whether or not there is an ejection failure by reading the printed base material by the scanner. When detecting the ejection failure, the inspection unit 27 can stop the image forming apparatus 20.

Next, the operation of the image forming apparatus 20 when performing the image forming processing will be described. First, the user creates job data with an external apparatus. The job data can include data of a print image indicating an image to be printed on the print target base material in accordance with the job. Then, the user transmits the job data from the external apparatus to the image forming apparatus 20 via the communication network. The user can transmit, to the image forming apparatus 20, control information regarding printing. For example, the user can perform print setting and quantity setting of a printed matter. Then, the user can transmit, from the external apparatus to the image forming apparatus 20, print setting information on the job and information on quantity of windings to be delivered together with the job data.

The data format of the print image is not particularly limited. For example, the data of the print image may indicate a spot color name of each pixel. The data of the print image may indicate a pixel for performing printing using a spot color material. For example, the data of the print image may include a background image indicating an area where print using a color material of a background (e.g., a white color material such as white ink) is performed. In one embodiment, when the color of a specific pixel indicated by the data of the print image is white, the ejection amount of ink of each of CMYK corresponding to this pixel is 0. On the other hand, the ejection amount of the white ink corresponding to this pixel can also be 0. Thus, the ejection amount of the white ink need not be controlled in accordance with color information on the pixel indicated by the data of the print image. In one embodiment, the ejection amount of the white ink is controlled in accordance with the information (white image) indicating the area where printing using the white ink is performed.

The control unit 24 of the image forming apparatus 20 receives job data and control information regarding print transmitted from an external apparatus via the communication unit 23. The image forming apparatus 20 can receive a job ticket including these pieces of information.

Next, the processing performed by the control unit 24 will be described in more detail. As illustrated in FIG. 2A, the control unit 24 can function as a reception unit 241, a determination unit 242, an information addition unit 243, a print instruction unit 244, and a setting unit 245.

The reception unit 241 receives a job. As described above, the reception unit 241 can receive a job ticket including job data and control information regarding printing from an external apparatus.

The determination unit 242 determines whether or not to print the background of a code image in a print image to be printed in accordance with the job. The code image is an image from which information can be read by a machine. In one embodiment, information is encoded in the code image. Such codes include a barcode. The barcode includes a one-dimensional barcode such as a UPC code and a two-dimensional barcode such as a QR code (registered trademark).

When a code image is printed, a background is often not printed. For example, the barcode can be expressed by a combination of white and black. In this case, the code image is often printed by ejecting black ink onto a black area without ejecting ink on a white area. On the other hand, by printing the background of the code image, the code image can be more easily read. For example, by ejecting the white ink onto the entirety of the white area and the black area or only the white area, the code image printed using the black ink can be more easily read. However, when the background of the code image is printed at all times, the consumption of the color material increases.

Legibility of the code image printed on the base material depends on the type of the base material. For example, it is not easy to read a barcode printed on a transparent base material. It may also be difficult to read a barcode printed on a colored base material. It may also be difficult to read a barcode printed on a base material with high reflectance. Therefore, in the present embodiment, the determination unit 242 determines whether or not to print the background, based on a result of estimating legibility of the code image printed on the print target base material. Such legibility can be estimated based on, for example, information indicating the type of the print target base material.

In one embodiment, the determination unit 242 determines whether or not to print the background based on information indicating the type of the print target base material. When determining that the print target base material is a predetermined type of base material (e.g., normal paper), the determination unit 242 can determine to print the background of the code image. The type of print target base material may be indicated by control information regarding print received from an external apparatus. For example, in addition to the job data, the user can transmit, from the external apparatus to the image forming apparatus 20, control information for designating the type of the print target base material. The type of the print target base material may be registered in the image forming apparatus 20 by the user. The setting unit 245 can perform print setting in accordance with a user input. For example, the user can designate the type of the print target base material via the operation display unit 26. The setting unit 245 can set the type of the print target base material in accordance with the user input via the operation display unit 26.

The user may register a new base material via the operation display unit 26. When registering the new base material, the user can register information on the base material (e.g., whether or not the base material is transparent). Furthermore, when the new base material is registered, information on the base material preset in the image forming unit 22 may be called. The user can modify, as needed, the information on the called base material to register it as information of the new base material.

In one embodiment, the determination unit 242 determines to print the background of the code image when the color of the print target base material is other than white. The determination unit 242 can determine whether or not the color of the base material is other than white based on the type of the print target base material. For example, when determining that the print target base material is a predetermined type of base material (e.g., normal paper), the determination unit 242 can determine that the print target base material is white. On the other hand, the information indicating the type of the print target base material may include information indicating the color of the base material.

In one embodiment, the determination unit 242 determines to print the background of the code image when the print target base material is transparent. The determination unit 242 can determine whether or not the color of the base material is transparent based on the type of the print target base material. For example, when determining that the print target base material is a predetermined type of base material (e.g., film paper), the determination unit 242 can determine that the print target base material is transparent. On the other hand, the information indicating the type of the print target base material may include information indicating transparency of the base material. The determination unit 242 may determine to print the background of the code image when the transparency has a predetermined value or more.

In one embodiment, the determination unit 242 determines to print the background of the code image when the print target base material has reflectivity. The determination unit 242 can determine whether or not the base material has reflectivity based on the type of the print target base material. For example, when determining that the print target base material is a predetermined type of base material (e.g., coated paper or metallic paper), the determination unit 242 can determine that the print target base material has reflectivity. On the other hand, the information indicating the type of the print target base material may include information indicating reflectance (e.g., specular reflectance) of the base material. The determination unit 242 may determine to print the background of the code image when the reflectance has a predetermined value or more.

The determination unit 242 may determine whether or not to print the background of the code image based on the information on the print target base material measured by the sensor. For example, the inspection unit 27 may include such a sensor. The sensor can measure the color, transparency, reflectance, or the like of the print target base material. The inspection unit 27 may include a light source that projects light to the base material, and a CCD or CMOS sensor that measures the color or intensity of light reflected by the base material or light transmitted through the base material.

In the present embodiment, in addition to the print image transmitted from an external apparatus, information regarding the job is printed on the print target base material. For this purpose, the control unit 24 functions as the information addition unit 243. The information addition unit 243 adds a code image indicating information regarding the job to the print image. However, it is not essential for the control unit 24 to function as the information addition unit 243.

The information addition unit 243 can generate a code image based on control information regarding printing. For example, the information addition unit 243 can generate a code image by encoding at least one of a job ID, a PDF file name, print date and time, the number of copies, and other character strings input by the user. Such a code image can be used, for example, for management of an obtained printed matter. However, the type of the code image is not particularly limited. For example, it is not essential for the code image generated by the information addition unit 243 to be based on control information regarding printing.

The information addition unit 243 can update the print image transmitted from the external apparatus so as to print the code image. The code image can be expressed by a combination of a foreground area (e.g., a bar) and a background area. The color of the foreground area is, for example, black. The color of the background area is, for example, white. On the other hand, the colors of the foreground area and the background area may be different colors.

The information addition unit 243 can generate the code image so as not to use a white color material or a color material of a background in order to record the background area. For example, the information addition unit 243 according to the present embodiment does not add the background image to the area of the code image.

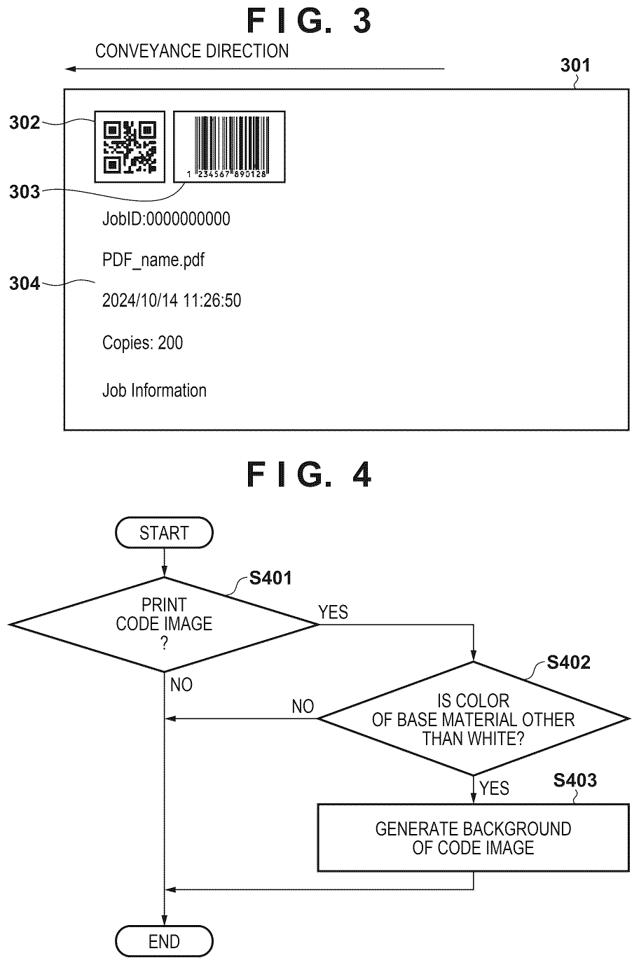

FIG. 3 illustrates an example of the job information to be added to the print image by the information addition unit 243. The information addition unit 243 adds job information 301 to the print image so as to print the job information 301 before the start page, after the tail page, or both before the start page and after the tail page of the printed matter in accordance with the job transmitted from the external apparatus via the communication unit 23.

FIG. 3 illustrates an example of a two-dimensional code image 302 and a one-dimensional code image 303. The information addition unit 243 can generate the two-dimensional code image 302 or the one-dimensional code image 303 based on the character string or the numerical information input from the operation display unit 26 or included in the job ticket. The job information 301 includes at least one of the two-dimensional code image 302 and the one-dimensional code image 303 as described above. The job information 301 includes a character string 304 including a job ID, a PDF file name, print date and time, the number of copies, and an arbitrary character string.

Whether or not to add job information can be set by the setting unit 245 in accordance with the user input via the operation display unit 26. The setting unit 245 may designate whether or not to add job information in accordance with the control information transmitted from the external apparatus via the communication unit 23. The arbitrary character string included in the character string 304 can be similarly set by the setting unit 245. Whether or not to print each of the two-dimensional code image 302 and the one-dimensional code image 303 can be similarly set by the setting unit 245.

The information addition unit 243 may add a character image, in addition to a code image, to the print image. Such a character image may indicate information regarding the job.

The information addition unit 243 can add the code image to the print image so as to be printed on the end of the print target base material. When the roll paper P is cut after print, the information addition unit 243 may add a code image to the print image so as to be printed in the vicinity of the cutting position. The information addition unit 243 may print the code image on the end of the print image.

The print instruction unit 244 instructs printing in accordance with the job received by the reception unit 241. For example, the print instruction unit 244 can control each unit including the image forming unit 22 so as to perform printing on the print target base material in accordance with the job data and control information. The print instruction unit 244 can determine the usage amount of each color material used by the image forming unit 22 corresponding to the color of each pixel indicated by the print image.

In the present embodiment, the print instruction unit 244 instructs printing in accordance with the job received by the reception unit 241 and the determination result by the determination unit 242. That is, the print instruction unit 244 can control the image forming unit 22 so as to perform printing in accordance with a result of determining whether or not to print the background of the code image. In the present embodiment, the print instruction unit 244 instructs to print the background of the code image added by the information addition unit 243 in accordance with the determination result by the determination unit 242. For example, the print instruction unit 244 can update the print image so as to print the background of the code image added by the information addition unit 243, and provide an instruction to print in accordance with the updated print image.

In the present embodiment, the background is printed using a white color material. The print instruction unit 244 can add a background image to an area of the code image or an area surrounding the code image included in the print image. In this case, the image forming unit 22 performs printing using the white color material on the entire area of the code image. Then, the image forming unit 22 can print the foreground area of the code image on the white color material. Note that the print instruction unit 244 may add the background image to the background area of the code image included in the print image.

FIG. 4 is a flowchart of the control method of the image forming apparatus according to one embodiment. By the processing shown in FIG. 4, it is determined whether or not to print the background of the code image according to the type of the base material. The processing according to FIG. 4 is performed after the information addition unit 243 adds the code image to the print image included in the job.

In S401, the determination unit 242 determines whether or not to print the code image. In the present embodiment, when the setting unit 245 sets printing of job information including the code image, the determination unit 242 determines to print the code image. When the determination unit 242 determines to print the code image, the processing proceeds to S402. Otherwise, the processing of FIG. 4 ends.

In S402, the determination unit 242 determines whether or not to print the background of the code image based on the result of estimating the legibility of the code image printed on the print target base material. In the present embodiment, as described above, the determination unit 242 determines whether or not to print the background of the code image based on the information indicating the type of the print target base material. For example, when the determination unit 242 determines that the color of the base material is other than white, the processing proceeds to S403. Otherwise, the processing of FIG. 4 ends.

In S403, the print instruction unit 244 adds the background image to the code image added to the print image by the information addition unit 243. For example, the print instruction unit 244 adds a white image to be printed using a color material (e.g., white ink) of the background to a rectangular area of the code image. This rectangular area can be an area surrounded by outer lines of the two-dimensional code image 302 and the one-dimensional code image 303, for example.

After the processing of FIG. 4 ends, the print instruction unit 244 controls the image forming unit 22 so as to perform printing on the base material based on the obtained print image.

According to the present embodiment, whether or not to print the background of the code image is controlled based on the result of estimating the legibility of the code image printed on the print target base material, for example, the type of the base material. Therefore, it is possible to reduce the consumption of the color material for printing the code image while maintaining the reading accuracy of the code image.

### Modified Embodiment: Print Control of Background of Code Image Based on Information Indicating Color Material Used for Print

The estimation method of the legibility of the code image printed on the print target base material is not limited to the method of referring to the information indicating the type of the print target base material. For example, the legibility of the code image can be estimated based on the information indicating the color material used for print.

For example, the determination unit 242 may determine whether or not to print the background of the code image based on whether or not it is designated to perform print using a specific color material in the job. For example, the determination unit 242 can determine to print the background of the code image when the print image transmitted from the external apparatus includes a pixel for performing printing using a specific color material. When the control information received by the reception unit 241 designates that print using a specific color material is performed, the determination unit 242 can determine to print the background of the code image. The specific color material may be a predetermined color material used for printing the background, such as a white color material (e.g., white ink). For example, when the print image includes the white image described above or when the print image includes a white pixel to be printed using white ink, the determination unit 242 can determine to print the background of the code image. The fact that the print image includes the area to be printed using the color material for the background suggests that printing of the background onto the print target base material is desired, for example, the print target base material is transparent or not white.

FIG. 6 is a flowchart for determining whether or not to print a background of a code image in such a modification. The processing shown in FIG. 6 can be performed in place of the processing shown in FIG. 4. S601 is similar to S401. In S602, the determination unit 242 determines whether or not the print image includes a pixel for performing printing using a specific color material. For example, when the print image includes a pixel to be recorded with white ink, the determination unit 242 can determine to print the background of the code image. When the determination unit 242 determines to print the background of the code image, the processing proceeds to S603. Otherwise, the processing of FIG. 6 ends. S603 is similar to S403.

As still another method, the legibility of the code image may be estimated based on the readability of the code image. For example, the print instruction unit 244 can control the image forming unit 22 so as to print a code image without a background onto the print target base material as a test code image. This code image may be a code image generated by the information addition unit 243 as described above or a prescribed code image. The inspection unit 27 can read the printed code image without the background. Here, when the inspection unit 27 can correctly read the code image without the background, the determination unit 242 can determine not to print the background of the code image. When the inspection unit 27 cannot correctly read the code image without the background, the determination unit 242 can determine to print the background of the code image.

### Modified Embodiment: Print Control of Background of Code Image in Consideration of Automatic Background Generation Setting

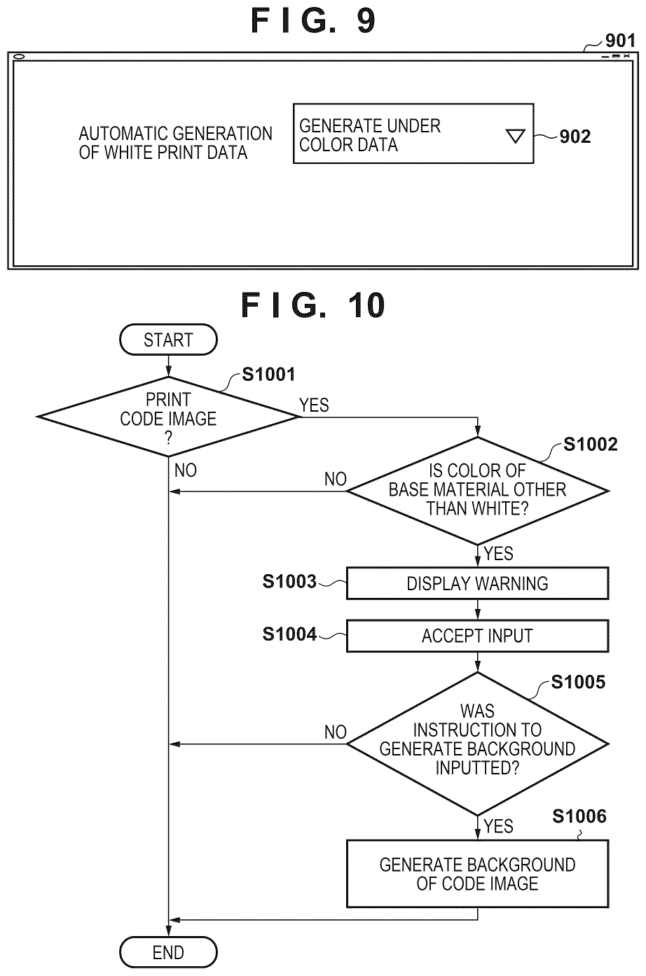

The image forming apparatus 20 may print the background in accordance with the automatic background generation setting. For example, the setting unit 245 can perform the automatic background generation setting. The setting unit 245 can perform the automatic background generation setting in accordance with the user input via the operation display unit 26 or in accordance with the control information transmitted from the external apparatus. The setting unit 245 can cause the operation display unit 26 to display a GUI 901 illustrated in FIG. 9 in order to receive a user input. The GUI 901 can receive an automatic background generation setting value 902.

For example, the setting unit 245 can set whether or not to print the background of the print image. The setting unit 245 can set a condition for printing the background. In the present embodiment, the automatic background generation setting value includes “OFF” indicating not printing the background. The automatic background generation setting value can include “generate under color data” indicating printing the background on a portion to be color printed. The automatic background generation setting value can include “generate on the entire area” indicating printing the background on the entire area to be printed.

FIG. 8 is a flowchart showing the processing of generating a background image in accordance with the automatic background generation setting. By the processing according to FIG. 8, the background image is added, in accordance with the setting, to the print image transmitted from the external apparatus via the communication unit 23.

In S801, the determination unit 242 determines whether or not the print image included in the received job includes a pixel for performing printing using a color material (e.g., white ink) used for printing of the background. When the determination unit 242 determines that the print image includes the pixel for performing printing using the color material used for printing of the background, the processing of FIG. 8 ends without adding the background image. Otherwise, the processing proceeds to S802. In this way, in one embodiment, when the print image includes a pixel for performing printing using a color material used for printing of the background, addition of the background image by the processing of FIG. 8 is not performed. Such a configuration enables printing so as to reflect designation of the area where printing using the color material of the background is performed and the area where printing using the color material of the background is not performed, which are indicated by the print image. However, the processing of S801 may be omitted.

In S802, the determination unit 242 determines the setting value of the automatic background generation setting. When the setting value indicates “generate on the entire area”, the processing proceeds to S803. When the setting value indicates “generate under color data”, the processing proceeds to S804. When the setting value indicates “OFF”, the processing of FIG. 8 ends without adding the background image.

In S803, the print instruction unit 244 adds the background image to the entire page of the received job (e.g., the entire print image included in the job). In step S804, the print instruction unit 244 adds the background image to a portion to be color printed in the print image included in the job. In the present description, the part to be subjected to color printing refers to a pixel where recording is performed using any of the color materials of C, M, Y, and K.

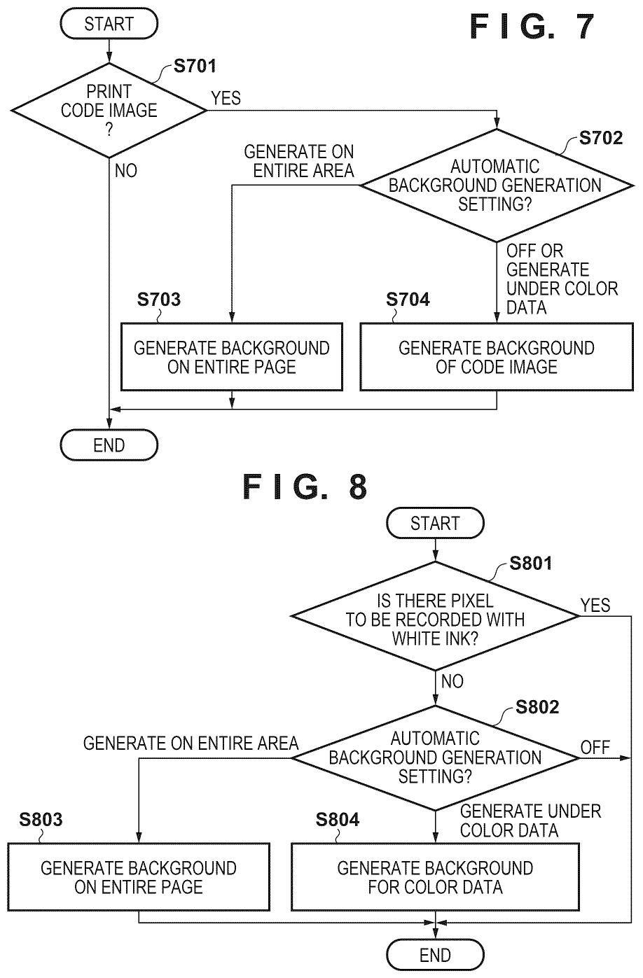

FIG. 7 is a flowchart for determining whether or not to print a background of a code image in such a modified embodiment. The processing shown in FIG. 7 can be performed in place of the processing shown in FIG. 4. The processing according to FIG. 7 may be performed before or after the processing according to FIG. 8. S701 is similar to S401. In S702, the determination unit 242 determines the setting value of the automatic background generation setting. When the setting value indicates “generate on the entire area”, the processing proceeds to S703. When the setting value indicates “generate under color data” or “OFF”, the processing proceeds to S704.

In S703, the print instruction unit 244 adds the background image to the entire page of the received job (the entire print image including the code image added by the information addition unit 243). In S704, similarly to S403, the print instruction unit 244 adds the background image to the code image added to the print image by the information addition unit 243.

According to the present embodiment, the background of the code image is printed even when the setting not to print the background of the print image (e.g., “OFF”) is made. That is, the print instruction unit 244 can provide an instruction to print so as to print the first background image as the background of the code image. On the other hand, even when the setting for printing the background of the print image (e.g., “generate on the entire area”) has been made, the print instruction unit 244 can provide an instruction to print so as to print the second background image. Here, the second background image can be made larger than the first background image. For example, the first background image can be added to an area of the code image or an area surrounding the code image that is narrower than the entire print image. On the other hand, the second background image can be set on the entire print image. According to such a configuration, it is possible to reduce the consumption of the color material for printing the code image while maintaining the reading accuracy of the code image.

Note that it is possible to combine the processing according to FIG. 7 and the processing of determining whether or not to print the background of the code image based on the result of estimating the legibility of the code image printed on the print target base material, which has been described with reference to FIGS. 4 and 6. For example, processing similar to that in S402 or S602 may be performed before S702. When the determination unit 242 determines to print the background of the code image by these processings, the processing may proceed to S702. Otherwise, the processing according to FIG. 7 may end.

### Modified Embodiment: User confirmation

The determination unit 242 may determine whether or not to print the background of the code image included in the print image based on the result of user confirmation in addition to the result of estimating the legibility of the code image. Such processing will be described with reference to FIG. 10. FIG. 10 is a flowchart for determining whether or not to print a background of a code image in such a modified embodiment. The processing shown in FIG. 10 can be performed in place of the processing shown in FIG. 4 or 6.

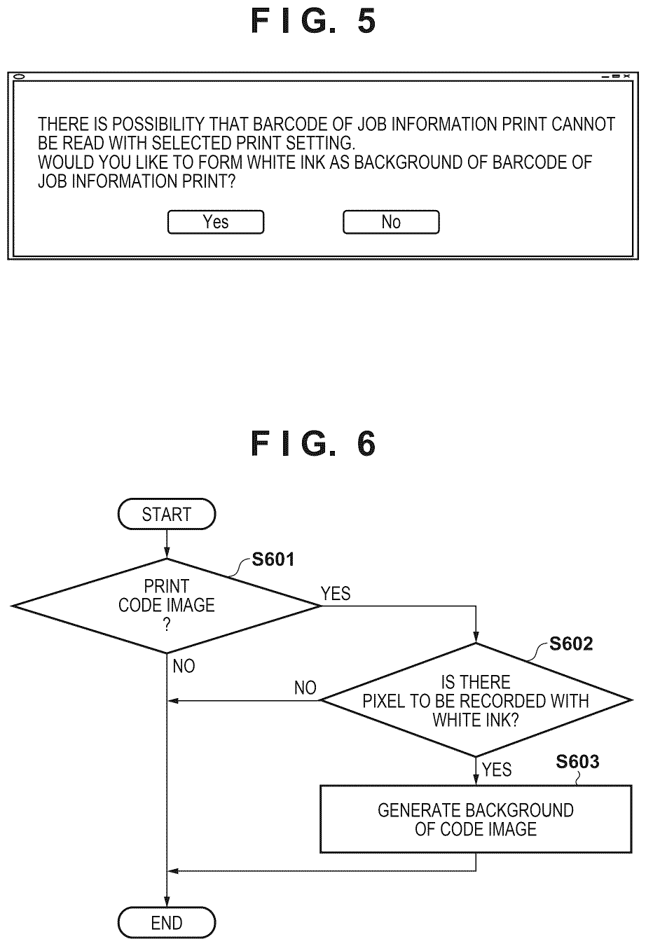

S1001 is performed similarly to step S401. In S1002, the determination unit 242 determines whether or not to make an inquiry to the user based on the result of estimating the legibility of the code image printed on the print target base material. The criterion for the determination can be similar to that in S402. In S1003, the determination unit 242 performs warning display. This warning display can notify the possibility that the code image cannot be read. The determination unit 242 can inquire of the user whether or not to print the background of the code image. The determination unit 242 may display a GUI as illustrated in FIG. 5 on the operation display unit 26.

In S1004, the determination unit 242 acquires, via the operation display unit 26, a user input indicating whether or not to print the background of the code image. In S1005, based on an answer to the inquiry, the determination unit 242 determines whether or not to print the background of the code image included in the print image to be printed in accordance with the print job. For example, in S1006, the determination unit 242 can determine whether or not the user input acquired in S1004 indicates printing the background of the code image. When the determination unit 242 determines that the user input indicates printing the background of the code image, the processing proceeds to S1006. Otherwise, the processing of FIG. 10 ends. The processing of S1006 is performed similarly to S403.

Note that the determination unit 242 may control whether or not to perform the processing of S1003 to S1005 according to the type of the print target base material. The processing shown in FIG. 10 may be combined with the processing shown in FIG. 7. For example, the processing of S1003 to S1005 may be performed before S704. According to such a configuration, when the setting not printing the background of the print image (e.g., “OFF”) is made, it is possible to inquire of the user whether or not to print the background of the code image. Then, in accordance with the user input designating printing of the background of the code image, the print instruction unit 244 can provide an instruction to print so as to print the background of the code image.

### Type of Code Image

In the embodiment described above, the determination unit 242 determines whether to print the background of the code image added by the information addition unit 243. However, the code image that is a target in which the background is printed is not limited to the code image added by the information addition unit 243. For example, the print image included in the job received by the reception unit 241 may include a code image. In this case, in accordance with the above-described method, the determination unit 242 can determine whether to print the background of the code image included in the print image.

For example, the control information received by the reception unit 241 may include information indicating the presence or absence of the code image in the print image. In this case, in S401, the determination unit 242 can determine whether or not to print the code image in accordance with the control information. The control information may include information indicating the area of the code image in the print image. In this case, in S403, the print instruction unit 244 can provide an instruction to print so as to print the background in the area of the code image indicated by the control information.

As another example, in S401, the determination unit 242 may determine the presence or absence of the code image in the print image by image recognition processing. In this case, in S403, the print instruction unit 244 can provide an instruction to print so as to print the background in the area of the code image recognized by the determination unit 242.

Printing the background of the barcode at all times increases the consumption of the color material (e.g., white ink).

One embodiment of the present disclosure can reduce consumption of a color material for printing a code image while maintaining reading accuracy of the code image.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-154232, filed Sep. 6, 2024, which is hereby incorporated by reference herein in its entirety.

What is claimed is:

1. An image forming apparatus comprising one or more memories storing instructions and one or more processors that execute the instructions to:
receive a print job;
determine, based on a result of estimating legibility of a code image printed on a print target base material, whether or not to print a background of a code image included in a print image, wherein the print image is to be printed in accordance with the print job; and
provide an instruction to print in accordance with the print job and a result of the determination.

2. The image forming apparatus according to claim 1, wherein the one or more processors execute the instructions to determine whether or not to print the background of the code image included the print image based on information indicating a type of the print target base material or information indicating a color material to be used for print.

3. The image forming apparatus according to claim 1, wherein the background is printed using a white color material.

4. The image forming apparatus according to claim 1, wherein the one or more processors execute the instructions to add a code image to the print image, the code image indicating information regarding the print job.

5. The image forming apparatus according to claim 4, wherein the one or more processors execute the instructions to provide the instruction to print so as to print the background of the code image having been added in accordance with the result of the determination.

6. The image forming apparatus according to claim 1, wherein the one or more processors execute the instructions to determine to print the background of the code image when a color of the print target base material is other than white.

7. The image forming apparatus according to claim 2, wherein the information indicating the type of the print target base material includes information indicating a color of the base material.

8. The image forming apparatus according to claim 1, wherein the one or more processors execute the instructions to determine to print the background of the code image when the print target base material is transparent.

9. The image forming apparatus according to claim 2, wherein the information indicating the type of the print target base material indicates transparency of the base material.

10. The image forming apparatus according to claim 1, wherein the one or more processors execute the instructions to determine whether or not to print the background of the code image based on information indicating a type of the print target base material received together with the print job.

11. The image forming apparatus according to claim 1, wherein the one or more processors execute the instructions to determine whether or not to print the background of the code image based on information indicating a type of a print target base material registered by a user.

12. The image forming apparatus according to claim 1, wherein the one or more processors execute the instructions to determine whether or not to print the background of the code image based on information on a print target base material measured by a sensor.

13. The image forming apparatus according to claim 1, wherein the one or more processors execute the instructions to determine whether or not to print the background of the code image based on whether or not a print image included in the print job having been received includes a pixel for performing printing using a specific color material.

14. The image forming apparatus according to claim 1, wherein the one or more processors execute the instructions to:
set whether or not to print a background of the print image, and
provide the instruction to print so as to print a first background image as the background of the code image, in response to setting not to print a background of the print image and the determination to print the background of the code image.

15. The image forming apparatus according to claim 1, wherein the one or more processors execute the instructions to determine whether or not to make an inquiry to a user based on the result of estimating the legibility of the code image printed on the print target base material, and determines, based on an answer to the inquiry, whether or not to print the background of the code image included the print image, wherein the print image is to be printed in accordance with the print job.

16. An image forming apparatus comprising one or more memories storing instructions and one or more processors that execute the instructions to:
set whether or not to print a background of a print image;
receive a print job; and
provide an instruction to print in accordance with the print job so as to print a first background image as a background of a code image included in a print image in response to a setting not to print a background of the print image, wherein the print image is to be printed in accordance with the print job.

17. The image forming apparatus according to claim 16, wherein the one or more processors execute the instructions to provide the instruction to print in accordance with the print job so as to print a second background image larger than the first background image in response to a setting to print the background of the print image.

18. A method of controlling an image forming apparatus, comprising:
receiving a print job;
determining, based on a result of estimating legibility of a code image printed on a print target base material, whether or not to print a background of a code image included in a print image, wherein the print image is to be printed in accordance with the print job; and
providing an instruction to print in accordance with the print job and a result of the determination.

19. A non-transitory computer-readable medium storing a program executable by a computer to perform a method of controlling an image forming apparatus comprising:
receiving a print job;
determining, based on a result of estimating legibility of a code image printed on a print target base material, whether or not to print a background of a code image included in a print image, wherein the print image is to be printed in accordance with the print job; and
providing an instruction to print in accordance with the print job and a result of the determination.
